(19) United States
(12) Patent Application Publication
(10) Pub. No.: US 2004/0134387 A1
(43) Pub. Date: Jul. 15, 2004

(54) Additives for the building industry obtained from plant by-products or waste and manufacturing process thereof

(76) Inventor: Alessandro Quadrio Curzio, Lecco (IT)

Correspondence Address: YOUNG & THOMPSON, 745 SOUTH 23RD STREET 2ND FLOOR, ARLINGTON, VA, 22202

(21) Appl. No.: 10/474,211

(22) PCT Filed: Apr. 4, 2002
(86) PCT No.: PCT/IB02/01159

(30) Foreign Application Priority Data
Apr. 5, 2001 (IT) MI01A0007336

(51) Int. Cl. C04B 40/00

(52) U.S. Cl. 106/819; 106/823

(57) ABSTRACT

Additives for the building sector obtained from plant by-products or waste suspended through wet-grinding of aggregates thereof are disclosed. Such additives may be chosen among silica fume, fly ashes, heavy ashes, slags or stone sludge, in form of pellets, sludge or blocks. The invention also relates to a process for preparing the additives in which the plant by-products and/or waste are wet-ground and suspended by means of a microballs mill.

### TECHNICAL FIELD OF THE INVENTION

The present invention relates to building additives obtained from by-products or waste, in particular silica fume or fly ash, and to a process for manufacturing such additives.

### BACKGROUND OF THE INVENTION

Ever since ancient times, the so-called pozzolanic materials have been used for building. The first material of this type to be ever used was pozzolana, a material of volcanic nature, after which the entire category is named. Among the synthetic pozzolanic materials, burnt and ground clay (the so called “cocciopesto”) is well known. As it is known, pozzolana, mixed with water and lime, can harden at room temperature, producing chemical compounds very similar to those obtained from hydration of Portland cement. Moreover, pozzolanic materials also react with lime formed by cement hydration. More recently, silica fumes and fly ashes have been included among pozzolanic materials. Apart from their pozzolanic properties, these substances may be used as fillers, since the extremely small size of their single particles allows them to fill the voids between the cement grains, resulting in a reduction of the microporosity of the products.

Silica fume and fly ashes are by-products of some industrial reactions. Silica fume, a very fine powder (diameter between 0.05 and 0.5 μm, with average diameter from 0.1 to 0.2 μm) of silica, almost exclusively amorphous, is obtained as a by-product of the processing o silicon, by means of electric arc, of iron-silicon alloys or other silica-based metal alloys, according to the reaction:

SiO₂+C→SiO+CO→Si+CO₂ (1)

Silica fume is formed through exposition of the intermediate product to the air, according to the reaction:

2SiO+O₂→2SiO₂ (2)

Reaction (2) is a minority reaction [about 30% of reaction (1)], and therefore the quantities of silica fume produced are not very high.

Fly ash is a very fine powder (however, less fine than silica fume, having a diameter comprised between 1 and 100 μm) of silica, which is obtained as a by-product of powdered coal combustion in thermoelectric power plants. They are the lightest ashes, which are held back by the combustion fumes filters, hence the adjective “fly”. Fly ashes are often ground together with the other cement components to obtain pozzolans; they are also used directly, sometimes after being dry-ground, to produce concrete.

Normally these substances, when they are used as cement additives, are prepared as dry solids (usually powders), with a maximum humidity of 3%. Silica fume may also be prepared in a water slurry, prepared using turbo dissolving machines or cutting stirrers; for this preparation silica fume powders, both densified and non-densified, are normally used, which are most easily aggregated.

In fact, silica fume has a strong tendency to aggregate, with a consequent reduction of its “usable” granulometry, especially through electrostatic interactions, reducing its properties. This is well seen in FIGS. 1 to 3: in FIG. 1 it is shown how silica fume grains 1 penetrate into the voids between the cement grains 2. In FIG. 2 silica fume grains 1 are represented in very disaggregated form, whereas in FIG. 3 they are represented in partially aggregated form, such as they are found in non-densified powders. Fly ashes, contrary to silica fume, do not have a strong tendency to densify, but are much coarser than silica fume and, also for this reason, less effective.

The use of these additives poses many problems. Firstly, there is a procurement and storing problem. In fact, as seen in the introduction, these substances are plant by-products or even waste. Therefore, their production is totally unrelated to the market. In fact, there are some periods of overproduction, for example in august, when most building activities are closed for the summer holidays. In winter, on the other hand, when the demand for energy for the main productions is greatest, most producers stop their activities, so that the offer is low. These problems are particularly serious because of the storing difficulties typical of these materials. In fact, because of the low specific weight of solid powders, silos with an enormous capacity or huge quantities of bag-like containers (the so-called “big bags”) would be necessary in order to store the required quantities of product.

The only valid alternative is that of storing humid lumps (about 15-25% humidity), which, due to their humidity, avoid dispersion of the powders in the environment. This alternative, however, determines a stronger aggregation of the single particles with respect to the powders.

Another problem into which producers or users of these substances incur is that of transportation: since, as seen above, these additives are sold as solid powders, they are transported as such. But, due to their extremely fine granulometry, they have a very low specific weight, so as to require enormous volumes, which greatly affect the transportation costs.

The consequence that a great part of the production of these substances is disposed of or it requires chemical or mechanical treatments for disaggregating, with a substantial environmental impact, adds up to these problems.

### SUMMARY OF THE INVENTION

All the problems described above are brilliantly solved by the present invention, which relates to additives for the building sector obtained from plant by-products or waste, characterised in that said by-products or waste are suspended and wet-ground.

Preferably, pozzolana materials, such as silica fume and/or fly ashes, are used as plant by-products or waste. The additives used are suspended starting from products in the form of powder, pellets, sludge or blocks.

The present invention also relates to a process for preparing such additives, characterised in that the plant by-products and/or waste are suspended and wet-ground.

### BRIEF DESCRIPTION OF THE DRAWINGS

The present invention is now described in greater detail with reference to the accompanying drawings, in which:

FIG. 1 is a diagram showing how the additives penetrate into the voids between the cement grains;

FIG. 2 shows non-aggregated silica fume particles;

FIG. 3 shows partially aggregated silica fume particles;

FIG. 4 is a graphic showing the results of an exemplary embodiment of the present invention with respect to the prior art; and

FIG. 5 is a graphic showing the results of another exemplary embodiment of the present invention as compared to the prior art.

### BEST WAY OF CARRYING OUT THE INVENTION

As said in the introduction, the production of the by-products which are used as additives for the building sector currently follows times and rhythms which very much differ from the demand of market, as it is connected with the production demand of the main product. According to the present invention, the by-products, once formed, do not require specific care in being isolated. Once they are obtained in any form, they can be sent for storing, to be subsequently reused in times of shortage of material, and they can be partly sent directly to a humid grinding device, where they are first wetted and then ground. In the case of silica fume, this is subject, rather than to real grinding, to disaggregating of the agglomerates.

The part sent for storing may be partly humid (about 15-25% water), so as to avoid problems of powder dispersion in the atmosphere, and it may be stored even in lumps, with limited costs. When it is subsequently used, it will be necessary to add another certain quantity of water, to reach about 35-55% water, and to wet-grind it. Usually, before proceeding to wet-grinding, the product and the additional water are put into a stirrer which, keeping them stirred, mixes and at least partially disaggregates the solid components; from the stirrer, the mixture is usually introduced into a microballs mill, from which it comes out as a quite stable slurry, as it is made by very fine particles dispersed into water. The grinding method may be in one or more steps. A preliminary dry or low water-quantity grinding step may also be provided, in order to reduce the size of the solid components. The microballs mill has proved the preferred device for wet-grinding.

Additives may also be used in order to keep the slurry's viscosity low and/or assist the grinding and/or avoid chemical reactions, such as gelling, which occur with certain silica fumes.

Furthermore, additives typical of the building and cement sector may be used.

The present invention has so far been described for use with silica fume or fly ashes; however, it may be used with by-products of different nature, having pozzolana and/or filling properties, such as, for instance, heavy ashes, blast furnace slags, stone sludge or inert materials of various nature.

The waste of thermal processes and/or high-temperature chemical processing may also be used. In particular, the residuals of the incineration of urban solid waste or the combustion of biomasses have good pozzolanic properties. Among the latter, the combustion of chaff or rice husk should be mentioned.

The present invention is now described in greater detail, with reference to some specific examples of embodiment.

### EXAMPLE 1

Samples of silica fume, coming from different sources, were examined, under the form of non-densified powders, densified powders, pellets coming from plants, and humid and compact sludge or blocks (the latter being taken from old deposits or dumps). All sources were good level plants for the production of metal silicon or iron-silicon. The data on the specific surface, dry-measured in m²/g with the BET method, which were used here, are those stated by the supplier.

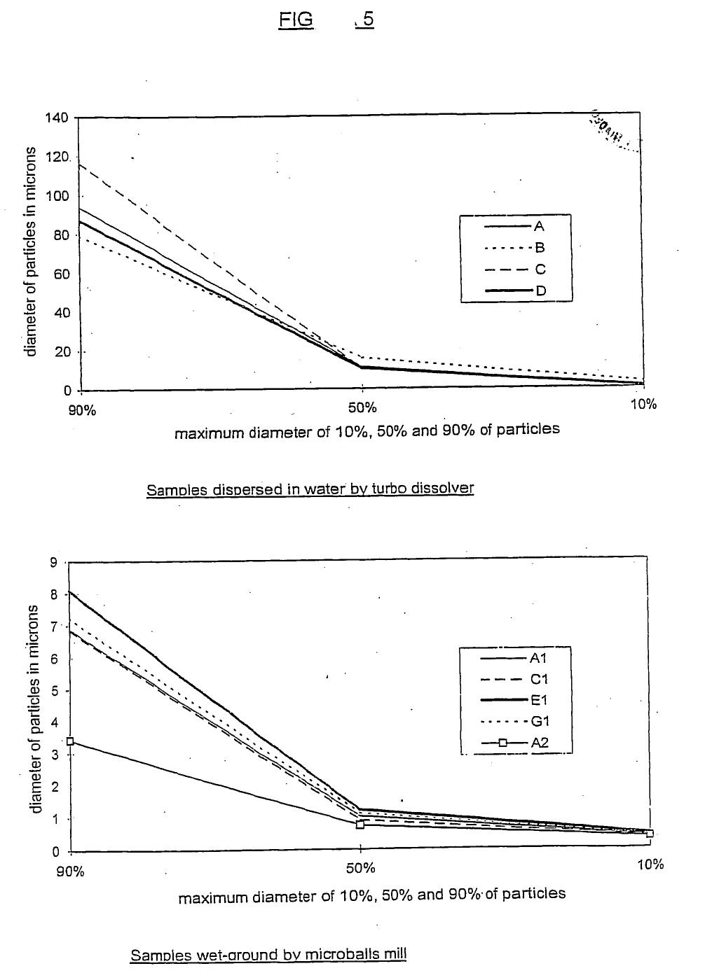

The samples were first disaggregated with a turbo dissolver in a slurry with about 50% water, and subsequently ground by means of a microballs mill. The results are summed up in the following Table 1. In it, the maximum diameter of 10%, 50% and 90% of the particles, expressed in microns, is indicated; the samples which underwent turbo dissolution are indicated as A, B, C, D, E, F, G, H, whereas A1, B1, C1, D1, E1, F1, G1 and H1 are the samples corresponding to the former, which, on the other hand, underwent wet-grinding according to the present invention. Samples A2 and B2 are samples that underwent wet-grinding, but for which optimal grinding parameters were found. The results are shown graphically in FIG. 4.

### TABLE 1

### Results of Example 1

| | Maximum | | | | |
|---|---|---|---|---|---|
| | diameter of 10%, | | | | |
| | 50% and 90% of the | | | Specific surface | Specific surface |
| | particles expressed | | | values wet- | values stated by |
| | in microns and | | | measured in m²/g | producer and dry- |
| | measured with laser | | | with laser | measured with |
| | granulometer | | | granulometer | B.E.T. method |
| | 90% | 50% | 10% | m²/g | m²/g |
| A | 94.08 | 11.42 | 0.67 | 2.42 | >12 |
| B | 102.96 | 10.93 | 0.66 | 2.52 | 23 |
| C | 116.78 | 10.59 | 0.88 | 1.90 | 18 |
| D | 87.34 | 10.61 | 0.82 | 1.95 | >15 |
| E | 83.72 | 10.80 | 0.59 | 2.69 | 24 |
| F | 68.25 | 9.26 | 0.58 | 2.84 | >20 |
| G | 33.66 | 4.48 | 0.53 | 3.78 | >15 |
| H | 23.40 | 3.57 | 0.48 | 4.52 | >10 |

### Samples Dispersed in Water with Turbodissolver

| | Maximum diameter | | | | |
|---|---|---|---|---|---|
| | of 10%, 50% and | | | | |
| | 90% of the particles | | | Specific surface | Specific surface |
| | expressed | | | values wet- | values stated by |
| | in microns and | | | measured in m²/g | producer and dry- |
| | measured with | | | with laser | measured with |
| | laser granulometer | | | granulometer | B.E.T. method |
| | 90% | 50% | 10% | m²/g | m²/g |
| A1 | 6.90 | 1.02 | 0.40 | 5.96 | >12 |
| B1 | 6.88 | 0.98 | 0.39 | 6.03 | 23 |
| C1 | 6.87 | 0.90 | 0.38 | 6.10 | 18 |
| D1 | 7.69 | 1.08 | 0.43 | 5.84 | >15 |
| E1 | 8.10 | 1.22 | 0.45 | 5.43 | 24 |
| F1 | 7.83 | 1.37 | 0.46 | 5.75 | >20 |
| G1 | 7.25 | 1.12 | 0.41 | 5.94 | >15 |
| H1 | 7.23 | 1.17 | 0.46 | 6.07 | >10 |
| A2 | 3.41 | 0.74 | 0.35 | 7.89 | >12 |
| B2 | 3.68 | 0.63 | 0.36 | 8.03 | 23 |

### Wet-Ground Samples with Microballs Mill

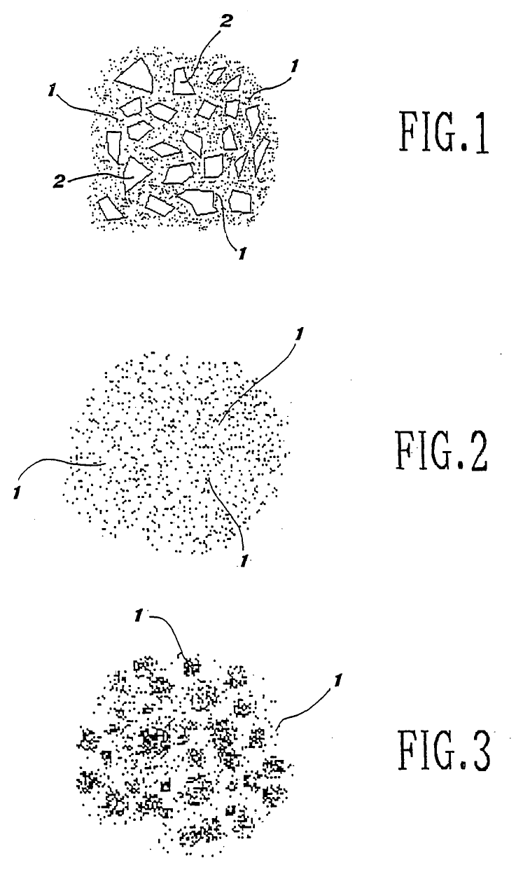

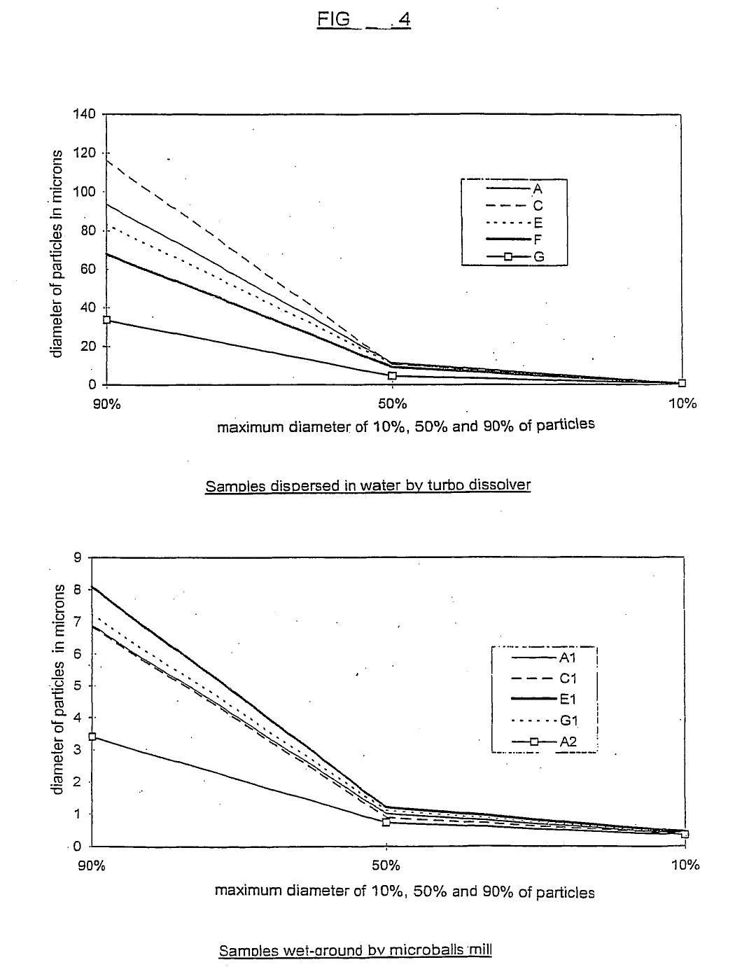

As it can easily be seen from the results obtained, when the turbo dissolver is used, there are no substantial differences depending on the source type of the silica fume used. The action was effective, since the obtained fineness was always comparable with that of the non-densified sample. However, as it can well be seen from FIG. 1, all samples have a high 90% value. Conversely, the wet-ground samples allowed obtaining 90% values which were not much higher than the 10% ones, thus obtaining slurries of perfectly disaggregated solids of a higher quality with respect to the products used so far.

### EXAMPLE 2

Three samples of fly ashes were examined. Also in this case, the samples underwent turbo dissolution in water slurry with about 40% water and were subsequently wet-ground according to the present invention. As seen in Table 2 and FIG. 5, the results are entirely similar to the former, allowing the obtaining of fly ashes of similar fineness to that of the silica fumes.

### TABLE 2

### Results of Example 2

| | | | | Specific surface |
|---|---|---|---|---|
| | | | | values wet- |
| | Maximum diameter of 10%, 50% and 90% | | | measured in |
| | of the particles expressed in microns | | | m²/g with laser |
| | and measured with laser granulometer | | | granulometer |
| | 90% | 50% | 10% | m²/g |
| A | 88.54 | 18.91 | 3.15 | 0.98 |
| B | 79.28 | 16.03 | 3.05 | 1.09 |
| C | 90.29 | 20.62 | 4.09 | 0.92 |
| D | 115.16 | 20.27 | 3.24 | 0.96 |
| E | 61.75 | 14.40 | 2.47 | 1.18 |

### Samples Dispersed in Water with Turbodissolver

| | | | | Specific surface |
|---|---|---|---|---|
| | | | | values wet- |
| | Maximum diameter of 10%, 50% and 90% | | | measured in |
| | of the particles expressed in microns | | | m²/g with laser |
| | and measured with laser granulometer | | | granulometer |
| | 90% | 50% | 10% | m²/g |
| A1 | 15.69 | 6.59 | 1.20 | 1.96 |
| B1 | 21.04 | 7.75 | 1.19 | 1.91 |
| C1 | 11.80 | 4.82 | 0.79 | 2.62 |
| D1 | 9.05 | 3.81 | 0.85 | 2.79 |
| E1 | 7.87 | 3.32 | 0.79 | 3.04 |
| F1 | 28.10 | 9.27 | 1.66 | 1.56 |
| G1 | 29.89 | 8.77 | 1.33 | 1.72 |
| H1 | 10.12 | 5.48 | 1.01 | 2.43 |
| I1 | 5.78 | 1.12 | 0.41 | 5.01 |
| L1 | 5.97 | 1.21 | 0.39 | 4.89 |

### Wet-Ground Samples with Microballs Mill

As said in the introduction, the properties of the silica fume and fly ashes as additives for building materials have long been known. With the present invention, the application field of such silica fumes and fly ashes is considerably enlarged, since silica fume or fly ashes slurries, useful for the building sector, may be obtained from any type of silica fume or fly ashes, including long-deposited sludge—thus disposing of deposits abandoned for years—so as to eliminate, in practice, the waste of these by-products and waste present in dumps, and to use up, with added value, the waste already disposed of. In addition, the consumption diagram is managed to be kept level, by storing accumulated slurry during the months (for example august) in which the building trade is inactive, in order to use it when the production plants stop (for example in winter), since it is possible to store the material in lumps with a certain quantity of water (about 15-25%), which is to avoid the dispersion of the powders in the atmosphere. Furthermore, by transporting small aggregated pellets, sludge or blocks, instead of powder, although these have a water percentage, transportation is substantially reduced, with a subsequent reduction of the environmental impact; also, more generic means of transport than before may be used.

The products obtained through wet-grinding are finer than those used so far, so that there are more advantages both as regards reactivity and the filling effect.

The present invention has been described so far with reference to exemplary embodiments thereof, but it is understood that various modifications are available to a person skilled in the art, without thereby departing from the protective scope thereof. In particular, filtration and/or separation steps of the components or impurities may be provided. It is further understood that the additives according to the invention may be obtained by suspending and wet-grinding either a single or more types of plant by-products or waste mixed together.

1) Additives for the building sector obtained from plant by-products or waste, characterised in that said plant by-products or waste are suspended and wet-ground.

2) Additives as in claim 1), characterised in that said plant by-products or waste are pozzolanic materials.

3) Additives as claims in 1) or 2), characterised in that silica fume is used as plant by-products or waste.

4) Additives as in claims 1) or 2), characterised in that fly ashes are used as plant by-products or waste.

5) Additives as in any of the preceding claims, characterised in that the by-products or waste used come in pellets.

6) Additives as in any of claims 1) to 4), characterised in that the by-products or waste used come in sludge or blocks.

7) Additives as in any of claims 5) and 6), characterised in that said by-products or waste are heavy ashes.

8) Additives as in any of claims 5) and 6), characterised in that said by-products or waste are blast furnace slags.

9) Additives as in any of claims 5) and 6), characterised in that said by-products or waste are stone sludge.

10) Additives as in any of claims 5) and 6), characterised in that said by-products or waste are generally inert.

11) Additives as in any of claims 5) and 6), characterised in that said by-products or waste come from thermal processes, such as high-temperature chemical processes or combustion processes.

12) Additives as in claim 11), characterised in that said by-products or waste come from incineration of urban solid waste.

13) Additives as in claim 11), characterised in that said by-products or waste come from combustion of biomasses.

14) Additives as in claim 13), characterised in that said by-products or waste come from combustion of chaff or rice husk.

15) Additives as in any of the preceding claims, characterised in that said by-products or waste are used in mixtures of two or more thereof.

16) Additives as in any of the preceding claims, characterised in that the content of water is comprised between 35 and 55% by weight.

17) Process for preparing the additives according to any of the preceding claims, characterised in that the by-products and/or waste are suspended and wet-ground.

18) Process as in claim 17), characterised in that a microballs mill is used for wet-grinding.

19) Process as in claims 17) and 18), characterised in that a preliminary dry or low water-quantity grinding of the by-products or waste to be suspended is provided.

20) Process as in any of claims 17) to 19), characterised in that additives to keep the viscosity low and/or assist the grinding and/or the dispersion and/or control the reactivity thereof are provided.

21) Process as in any of claims from 17) to 20), characterised in that wet-grinding is achieved in several steps.

22) Process as in any of claims 17) to 19), characterised in that filtration and/or separation steps of components or impurities are provided.
